(19) United States
(12) Patent Application Publication
(10) Pub. No.: US 2003/0074364 A1
(43) Pub. Date: Apr. 17, 2003

(54) Compressed data structure and decompression system

(76) Inventors: Patrick M. Sewall, Boise, ID (US); R. Russell Campbell, Boise, ID (US); Daniel L. George, Boise, ID (US); Lon Berk Radin, Palo Alto, CA (US)

Correspondence Address: HARRINGTON & SMITH, LLP, 4 RESEARCH DRIVE, SHELTON, CT, 06484-6212, US

(21) Appl. No.: 09/977,713

(22) Filed: Oct. 12, 2001

(51) Int. Cl. G06F 7/00

(52) U.S. Cl. 707/101

(57) ABSTRACT

A compressed data structure and decompression system suitable for use in portable devices. The data structure and decompression system of the present invention help reduce power consumption and minimize the amount of non-volatile memory needed to support a computing system. In one embodiment of the invention, the data structure contains a plurality of code strings and a plurality of look-up strings. Each look-up string includes an index identifying a particular code string to be retrieved and an instruction identifying an operation to be performed on the retrieved code string. To decompress the data structure, software or other programming reads through each of the look-up strings. For each look-up string the programming retrieves a code string and performs an operation on that code string according to the index and instruction of the look-up string.

### FIELD OF THE INVENTION

The present invention is directed to a compressed data structure and a method and system for decompressing the data structure.

### BACKGROUND OF THE INVENTION

Throughout the years, the architecture of computing systems has remained substantially unchanged. Typically, at the heart of a computing system is a central processing unit (CPU) coupled to a system memory. The system memory is usually volatile and is erased when the system is powered down. The computing system also includes a separate graphical interface for coupling to a video display as well as input/output (I/O) control logic for various I/O devices, including a keyboard, mouse, floppy drive, hard drive, among others.

FIG. 1 illustrates a typical computing system 10 including CPU 12, volatile memory 14, and non-volatile memory 16. Volatile memory 14 represents generally any memory, such as DRAM (Dynamic Random Access Memory) and SRAM (Static Random Access Memory), that loses its contents when the power is turned off. Non-volatile memory represents generally an I/O device such as a floppy disk, hard drive, or other form of memory that is retained even when power is turned off. In general, the operation of computing system 10 is as follows. Stored programs 18 and data 20 are read from non-volatile memory 16 and transferred into volatile memory 14 and are shown as programs and data in use 22 and 24. CPU 12 then executes program in use 22 from volatile memory 14. CPU 12 processes the instructions of program 22, and the resulting data is provided to one or more of the various output devices (not shown). Computing system 10 may include several output devices, including a video display, audio speakers, and printers, among many others.

In the past, such computing systems were usually only found in personal computers, servers, and other conventional computing devices. Today, however, computing systems are being embedded in appliances such as microwave ovens and refrigerators. They are also being embedded in portable devices such as cellular telephones, digital music players (commonly referred to as MP3 players), and PDA's (Personal Digital Assistants). It is with these portable devices that power consumption and available memory pose significant constraints on the computing system.

Most portable devices operate on battery power. Replacing or recharging batteries is a disagreeable task for any user. Consequently, extended battery life is an important, if not essential, marketing tool. Conventional nonvolatile memory sources, such as hard drives, are not practical for many portable devices. Hence, flash memory is commonly used for nonvolatile memory in portable devices. Flash memory is a special type of EEPROM (Electrically Erasable Programmable Read-Only Memory) that can be erased and reprogrammed in blocks instead of one byte at a time. Flash memory, like a hard drive, retains its contents even when power is turned off. Presently, flash memory is a relatively expensive option. Computing systems requiring large amounts of flash memory can dramatically increase the manufacturing cost of a portable device.

To decrease required flash memory, programs and other electronic data files are stored in a compressed state that much less space than the decompressed counterparts. When these programs and other data files need to be loaded for use, they are decompressed “on the fly” as part of the loading process. Consequently, what is needed is a compressed data structure and decompression system that reduces power consumption and minimizes the amount of required non-volatile memory.

### SUMMARY OF THE INVENTION

The present invention is directed to a compressed data structure and decompression system suitable for use in portable devices. The data structure and decompression system of the present invention help reduce power consumption and minimize the amount of non-volatile memory needed to support a computing system. In one embodiment of the invention, the data structure contains a plurality of code strings and a plurality of look-up strings. Each look-up string includes an index identifying a particular code string to be retrieved and an instruction identifying an operation to be performed on the retrieved code string. To decompress the data structure, software or other programming reads through each of the look-up strings. For each look-up string the programming retrieves a code string and performs an operation on that code string according to the index and instruction of the look-up string.

### DESCRIPTION OF THE DRAWINGS

FIG. 1 is a schematic representation of a typical computing system.

FIG. 2 is a schematic representation of a computing system in which the present invention may be embodied.

FIG. 3 is a schematic representation of a library according to one embodiment of the present invention.

FIG. 4 is a schematic representation of a library segment in the library of FIG. 3.

FIG. 5 is a schematic representation of a code string according to one embodiment of the present invention.

FIG. 6 is a schematic representation of a history cache according to one embodiment of the present invention.

FIG. 7 is a schematic representation of look-up data according to one embodiment of the present invention.

FIG. 8 is a schematic representation of a look-up string in the look-up data of FIG. 7.

FIG. 9 is a schematic representation of a decompression engine according to one embodiment of the present invention.

FIG. 10 is a flow diagram illustrating a data decompression process provided by the decompression engine of FIG. 9.

FIG. 11 is a block diagram illustrating an example of a library designed for an ARM (Advanced RISC Machine) processor.

FIG. 12 is a block diagram further illustrating the first library segment of the library of FIG. 11.

FIG. 13 is a table illustrating look-up strings designed to retrieve a code string from the library of FIG. 11 and write it to output memory.

FIG. 14 is a table illustrating look-up strings designed to retrieve a code string from the library, alter that code string, and then and write the altered code string to output memory.

FIG. 15A is a table illustrating look-up strings designed to retrieve a code string from the history cache and write it to output memory.

FIG. 15B is a second table illustrating look-up strings designed to retrieve a code string from the library and write it to output memory.

FIG. 16 is a table illustrating look-up string designed to write the index of the look-up string to output memory.

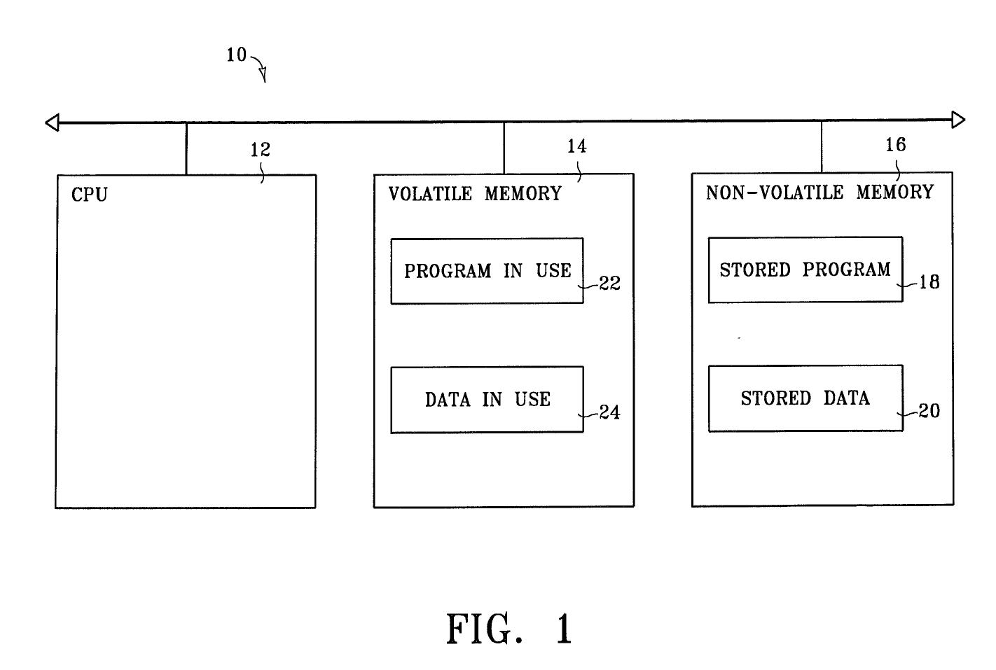

### DETAILED DESCRIPTION OF THE INVENTION

INTRODUCTION: The idea behind data compression is relatively simple. Efficiently compressing and then decompressing a data file or files, however, is another story. Every electronic data file, such as an application, electronic document, or other electronic information, consists of a binary string of bits—ones and zeros. A given string of bits can be broken into a series of code strings in the form of words, bytes, or other grouping of bits. A word is a string of thirty-two bits and a byte is a string of eight bits. Using words as an example, within a string that forms a given data file, some words are repeated, and some of those words are repeated more then others. Compression involves representing each of these repeated words with a representation string containing, in this example, fewer than thirty-two bits. If, for a given program, every word (thirty-two bits) could be represented with a byte (eight bits), then that program could potentially be compressed to one quarter its original size. Generally, however, representing each of the repeated words in a given data file requires representation strings of varying length. Representation strings containing the fewest bits are used to represent the most frequently repeated words while representation strings containing more bits are used to represent the least frequently repeated words.

A compressed data structure, according to the present invention, includes look-up data and a library. The library contains a number of entries—each entry being a repeated code string. The look-up data contains look-up strings. Each look-up string functions in part as a representation string that identifies an entry in the library or elsewhere. Each look-up string also includes data identifying an operation to be performed on the library entry identified by the look-up string. Each code string needed to make up the decompressed data file or files can be identified by reading through each of the look-up strings. Joining each of the identified code strings, then, forms the decompressed data file or files.

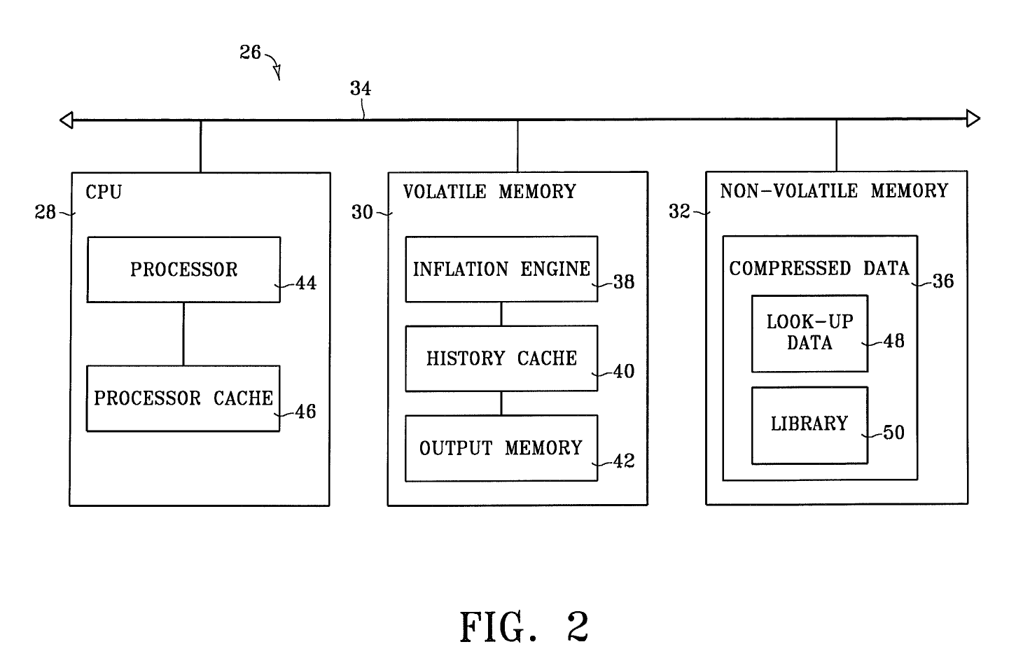

COMPONENTS: Although the various embodiments of the invention disclosed herein will be described with reference to the computing system 26 shown schematically in FIG. 2, the invention is not limited to use with computing system 26. The invention may be implemented in or used with any system in which it is necessary or desirable to provide and decompress data structures. The following description and the drawings illustrate only a few exemplary embodiments of the invention. Other embodiments, forms, and details may be made without departing from the spirit and scope of the invention, which is expressed in the claims that follow this description.

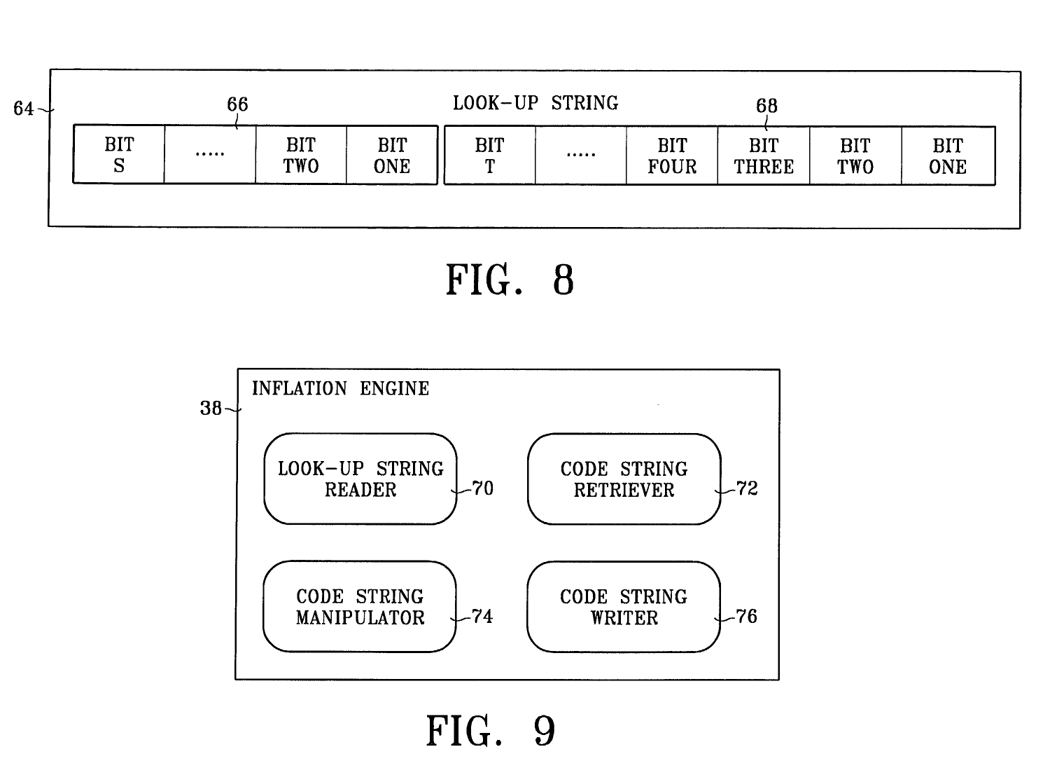

The logical components of one embodiment of the compressed data structure and decompression system will now be described with reference to the block diagrams of FIGS. 2-9. FIG. 2 illustrates computing system 26 containing CPU 28, volatile memory 30, non-volatile memory 32, and system bus 34. System bus 34 represents a communication link between CPU 28 and the other components 30 and 32. In this embodiment, the invention is implemented in compressed data structure 36 stored in non-volatile memory 32 as well as software or other programming labeled decompression program 38 operating from volatile memory 30. Compressed data structure 36 represents generally a software application or other electronic data stored in a compressed format. Decompression program 38 represents software or other programming when executed by CPU 28 is capable of decompressing compressed data structure 36. The term decompression engine, then refers generally to decompression program 38 being executed by CPU 28. One embodiment of decompression program 38 will be described in more detail below with reference to FIG. 9.

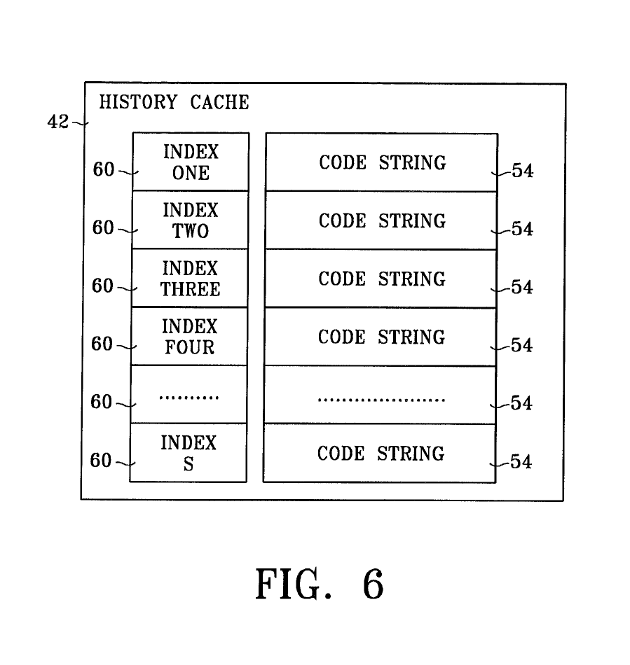

Still referring to FIG. 2, volatile memory 30 also contains history cache 40 and output memory 42. Output memory 42 represents a portion or portions of volatile memory 30 into which the program or other electronic data represented by compressed data structure 36 is decompressed by CPU 28 using decompression program 38. CPU 28, using decompression program 38, sequentially retrieves code strings from compressed data structure 36 and places those code strings into output memory 42. The retrieved code strings are joined to form the original/decompressed decompressed data file represented by compressed data structure 36. History cache 40 represents a memory location capable of containing copies of a specified number of the most recently retrieved code strings. The number of copies is typically determined by the amount of memory allocated to or available for history cache 40. History cache 40 will be described in more detail below with reference to FIG. 6.

As illustrated in FIG. 2, CPU 28 includes processor 44 and processor cache 46. Processor 44 is responsible for executing decompression program 38 as well as other programs contained in volatile memory 30 and elsewhere as well as accessing data from volatile and non-volatile memory 30 and 32. In general, a program is made up of a series of instructions each guiding CPU 28 to perform a particular task. As a program is being executed, particular instructions and data are often times repeatedly processed by CPU 28. Processor cache 46 represents memory for containing those instructions and data most often processed within a given time frame. As illustrated in FIG. 2, it is envisioned that processor cache 46 will be L1 (Level One) directly accessed by processor 44. This allows processor 44 to access the cached data at a rate or speed set by CPU 28. Typically the speed of CPU 28 is significantly greater than that provided by system bus 34. Allowing processor 44 to access this data and these instructions directly from processor cache 46, in many cases, significantly increases the overall speed of computing system 26. Increasing the overall speed while decreasing the frequency at which CPU accesses instructions and other data from memory 30 and 32 also decreases power consumption

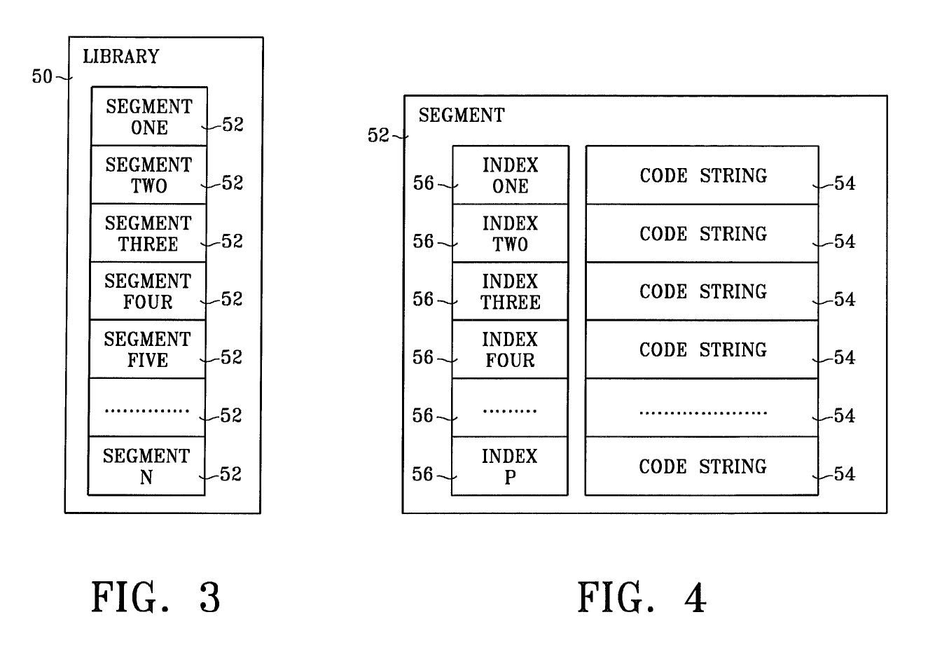

In FIG. 2, compressed data structure 36 includes look-up data 48 and library 50. Library 50, described in more detail below with reference to FIGS. 3-5, represents a grouping of code strings. As described above, decompression program 38 retrieves these code strings in a particular order joining them in output memory 42. Look-up data 48, described in more detail below with reference to FIGS. 7 and 8, represent data used to determine the particular order that the code strings are retrieved from library 50 and history cache 40 as well as instructions for altering a particular one code string before it is joined in output memory 42.

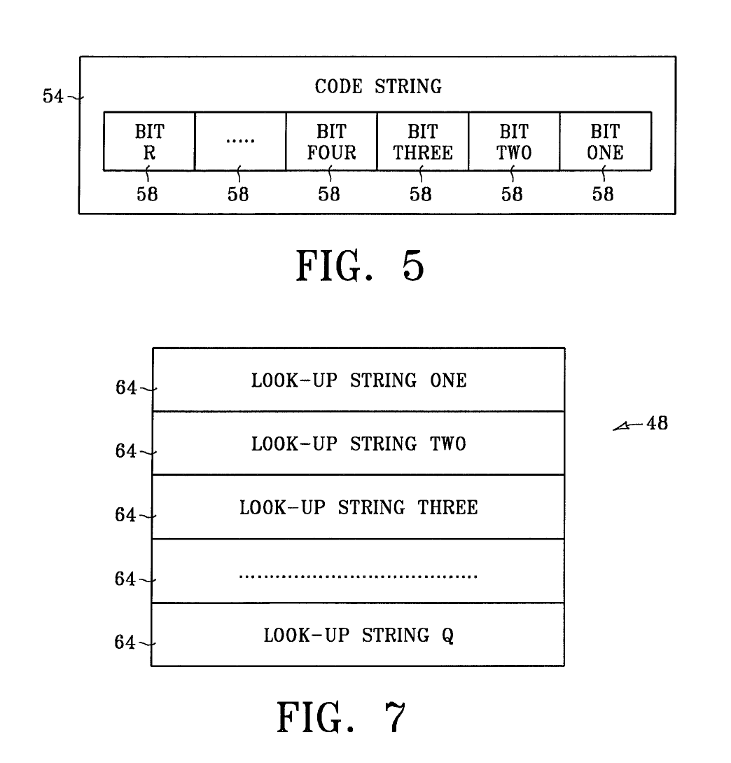

Referring now to FIGS. 3-5, library 50 is divided into multiple segments 52 (FIG. 3). Each segment 50 contains any number of code strings 54 each associated with an indexed position 56 (FIG. 4). Each code string 54 contains a selected number of bits 58 (FIG. 5). A particular code string 54 can be located within library 50 by ascertaining its address—that being its indexed position 56 and segment 52. As shown in FIG. 6, history cache 40 contains a selected number of indexed positions 60 with each position containing a code string 54 recently written to output memory 42. As noted above, the number of indexed positions 60 depends upon the amount of memory allocated to or available for history cache 40. History cache 40 provides a record of code strings 54 recently written to output memory 42. Copies of at least some of the code strings 54 written to output memory 42 are also written to history cache 40. As history cache 40 is filled to capacity, older code strings 54 are flushed to make room for the new. In the example of FIG. 6, as a new code string 54 is written to output memory 42, the existing code strings 54 in history cache 40 are each shifted down one indexed position 60. The code string 54 in the last indexed position, S in this case, is flushed. The code string 54 written to output memory 42 is then written to the now empty first indexed position 60.

Look-up data 48, as shown in FIG. 7, includes a series of look-up strings 64. Look-up strings 64 each represent data used to locate a particular code string 54 as well as data identifying an operation to be performed on that code string 54 by CPU 28 when executing decompression program 38. Described in greater detail below, these operations can include writing the code string 54 one or more times to output memory 42 or first altering code string 54 and then writing the altered code string 54 to output memory 42.

FIG. 8 illustrates one look-up string 64 in greater detail. Look-up string 64 is divided into two parts—instruction 66 and index 68. Instruction 66 represents data identifying an operation to be performed on a code string 54. If the code string 54 is to be retrieved from library 50 rather than history cache 40, instruction 66 also includes data identifying the library segment 52 from which the code string 54 is to be retrieved. Depending upon the operation to be performed on the retrieved code string 54, index 68 can represent data identifying the indexed position 56 of code string 54 within a particular library segment 52, the indexed position 60 of the code string 54 within history cache 40, as well as data representing a particular operation to be performed on the code string 54. As illustrated each look-up string 64 is in binary format with each instruction 66 and index 68 containing a selected number of bits. The number of bits in each is dependent upon a number of factors including the location of the code string 54 to be retrieved and the particular operation to be performed on that code string 54.

Referring now to FIG. 9, decompression program 38 includes look-up string reader 70, code string retriever 72, code string manipulator 74, and code string writer 76. Look-up string reader represents generally any programming enabling CPU 28 to sequentially read look-up strings 64 from look-up data 48. Code string retriever 72 represents any programming enabling CPU 28 to locate and retrieve a code string 54 identified using look-up string reader 70. Code-string manipulator 74 represents any programming enabling CPU 28 to alter a code string 54 as indicated by instruction 66 of look-up string 64. Code string writer 76 represents any programming enabling CPU 28 to write a code string 54 to history cache 40 and to output memory 42. When writing to output memory 42, code string writer 76 appends each code string 54 to code strings previously written to output memory 42. When writing to history cache 40, code string writer 76 shifts existing code strings 54 in history cache 40 down one indexed position 60 and writes the new codes string 54 to the first indexed position 60.

The block diagrams of FIGS. 2-9 show the architecture, functionality, and operation of one implementation of the present invention. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, the present invention can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain decompression program 38 and compressed data structure 36 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

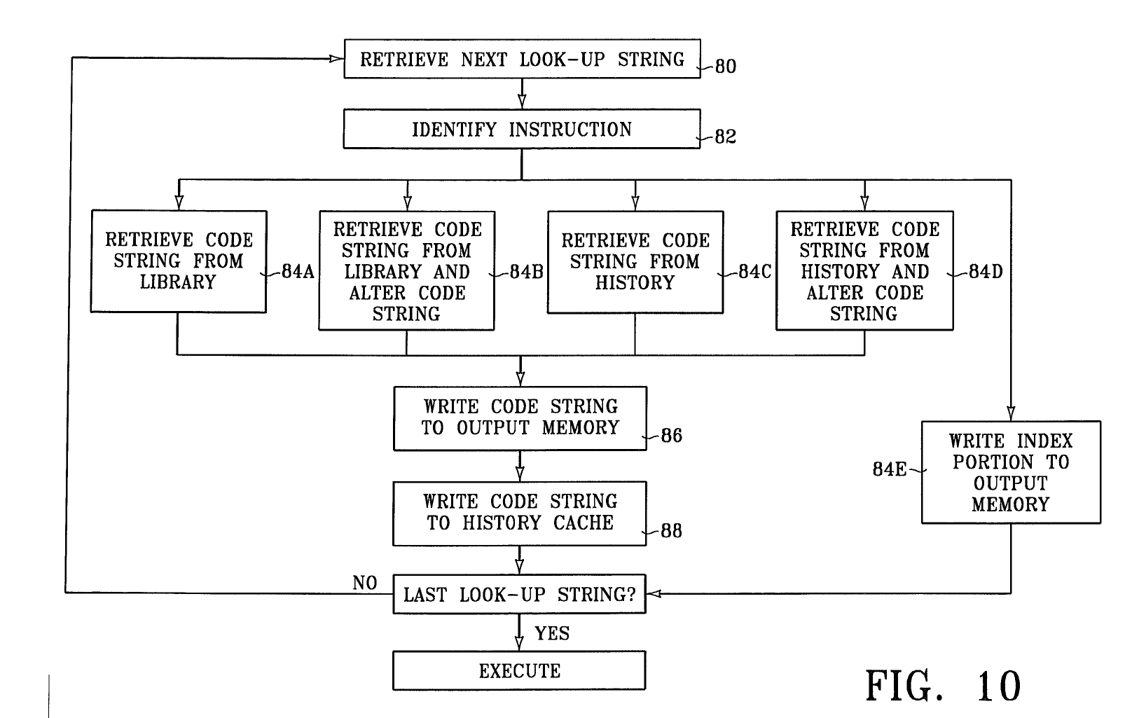

OPERATION: The operation of decompression program 38 and use of compressed data structure 36 will now be described with reference to the flow diagram of FIG. 10 as well as the preceding FIGS. 2-9. Executing decompression program 38, CPU 28 accesses non-volatile memory 32 and retrieves the first lookup string 64 from look-up data 48 (step 80). From that look-up string 64, CPU 28 then identifies a code string 54 to retrieve and an operation to perform on the retrieved code string 54 (step 82).

Steps 84A through 84C represent actions taken by CPU 28 depending upon the operation identified in the particular look-up string 64. In step 84A, CPU 28 retrieves the code string 54 from the segment 52 and index position 56 of library 50 as identified by the look-up string 64. In step 84A, CPU 28 retrieves and alters the code string 54 from the segment 52 and index position 56 of library 50 as identified by the look-up string 64. In step 84C, CPU 28 retrieves the code string 54 from the index position 68 of history cache 40 as identified by the look-up string 64. In step 84D, CPU 28 retrieves and alters the code string 54 from the index position 68 of history cache 40 as identified by the look-up string 64. Finally, in step 84E, CPU 28 writes the data contained in the index 68 of the look-up string 64 directly to output memory 42 joining that data to data previously written to output memory 42. In step 86, CPU 28 writes the code string 54 retrieved in steps 84A, B, C, or D and altered in steps 84B or 84D to output memory 42, joining that code string to data previously written to output memory 42. CPU 28 then writes the code string 54 to history cache 40 (step 88).

If the current look-up string 64 is the last string in look-up data 48, CPU 28 executes the program formed by each of the code strings written and joined in output memory 42 (step 90). Otherwise, CPU 28 repeats the process with step 80 retrieving the next look-up string 64 from look-up data 48.

Although the flow chart of FIG. 10 shows a specific order of execution, the order of execution may differ from that which is depicted. For example, the order of execution of two or more blocks may be scrambled relative to the order shown. Also, two or more blocks shown in succession in FIG. 10 may be executed concurrently or with partial concurrence. All such variations are within the scope of the present invention.

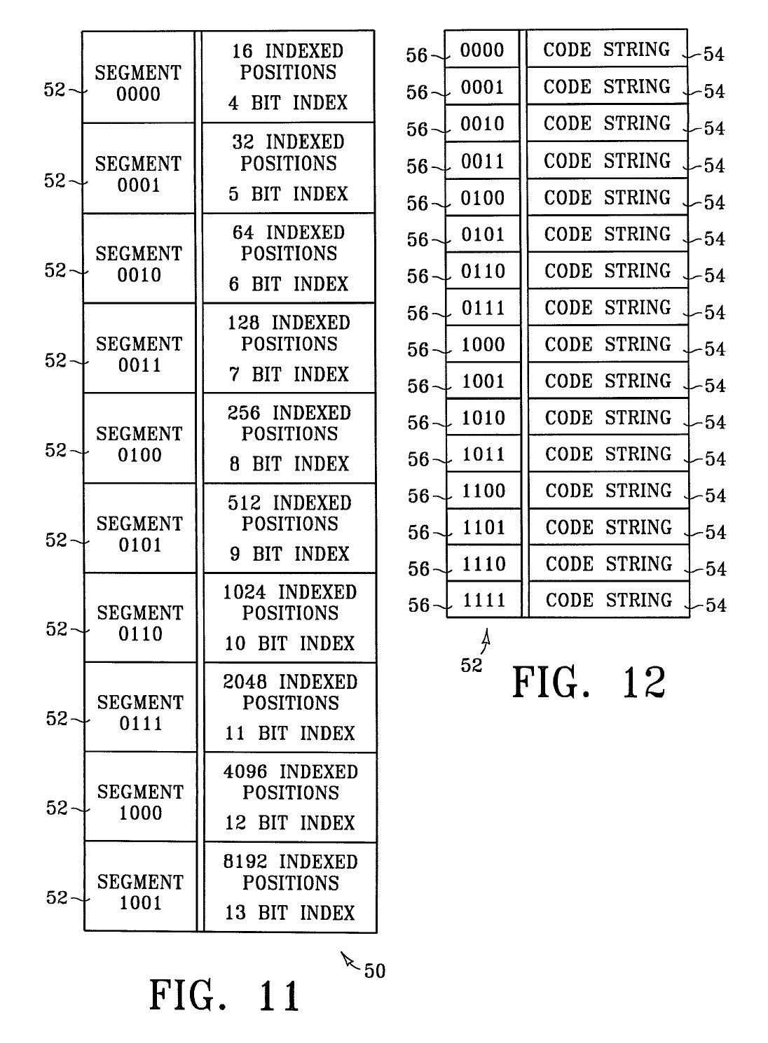

SAMPLE COMPRESSED DATA STRUCTURE: FIGS. 11-16 contain block diagrams and tables illustrating a compressed data structure designed for an ARM (Advanced RISC Machine) processor. FIG. 11 illustrates a sample library 50 made up of ten segments 52 containing varying numbers of indexed positions 56. Each segment 52 can be represented by a four bit binary string ranging between 0000 and 1010. The number of positions 56 in each successive segment 52 follows a binary progression increasing by a factor of two. The first segment 52 contains sixteen positions 56 while the tenth segment 52 contains over eight thousand positions 56. FIG. 12 further illustrates the first segment 52 of FIG. 11. In FIG. 12, first segment 52 contains sixteen indexed positions 56. As illustrated, each position can be represented by a four bit binary string ranging from 0000 to 1111. Each successive segment, then, requires one additional bit to identify a particular code string 54 in that segment. In this example, each code string 54 contains thirty-two bits 58.

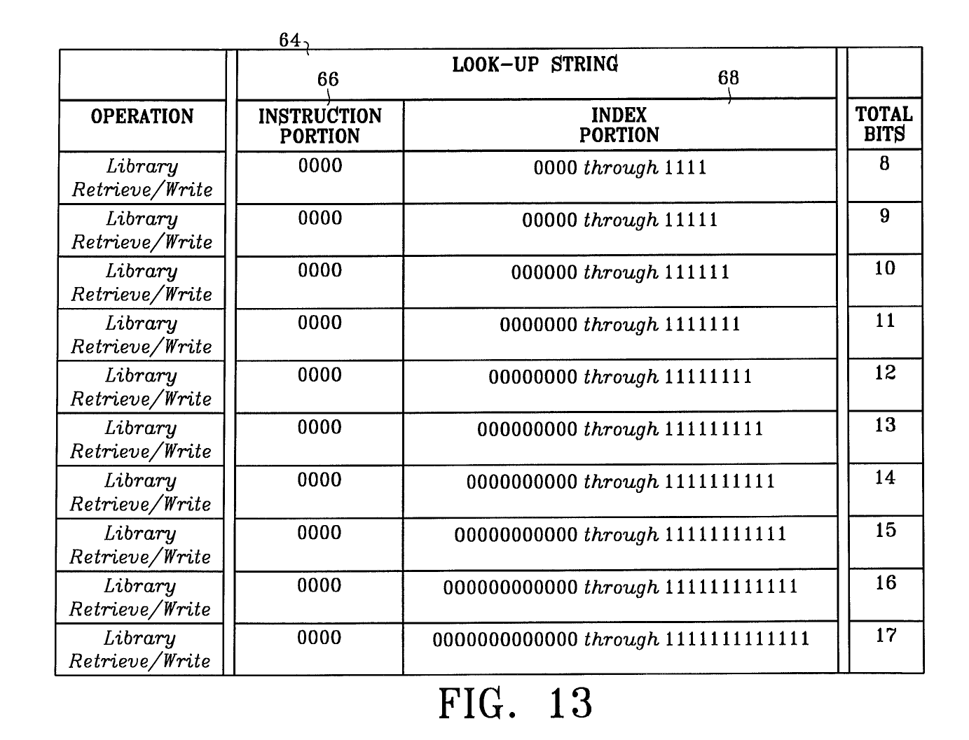

As described above with reference to FIG. 8, each look-up string 64 contains an instruction 66 and an index 68. FIG. 13 is a table representing look-up strings 64 designed to cause CPU 28, when executing decompression program 38, to retrieve a code string 54 from library 50 (FIGS. 11 and 12) and write that code string 54 without alteration to output memory 42. Instruction 66 includes bits identifying the library segment 52 from which a selected code string 54 is to be retrieved. The index 68, then, contains bits required to identify the indexed position 56 containing the selected code string 54. In this example, the instruction 66 to retrieve a code string 54 from library 50 is a four bit binary string ranging between 0000 and 1001 and the index 68 is a binary string ranging between four bits for the first library segment and thirteen bits for the last library segment. As a note, when read by CPU 28, instruction 66 in the range between 0000 and 1001 also acts as a guide for CPU 28 to retrieve a code string 54 from a particular segment 52 of library 50 rather than from history cache 40 and write that code string 54 without alteration to output memory 42. As can be seen from the table of FIG. 13, each thirty-two bit code string 54 in library 50 can be identified using a look-up string 64 of between eight and seventeen bits. To maximize compression, the sixteen most retrieved code strings 54 are generally found in the first library segment 52—the next thirty-two most retrieved in the second segment 52—the next sixty-four in the third—and so on.

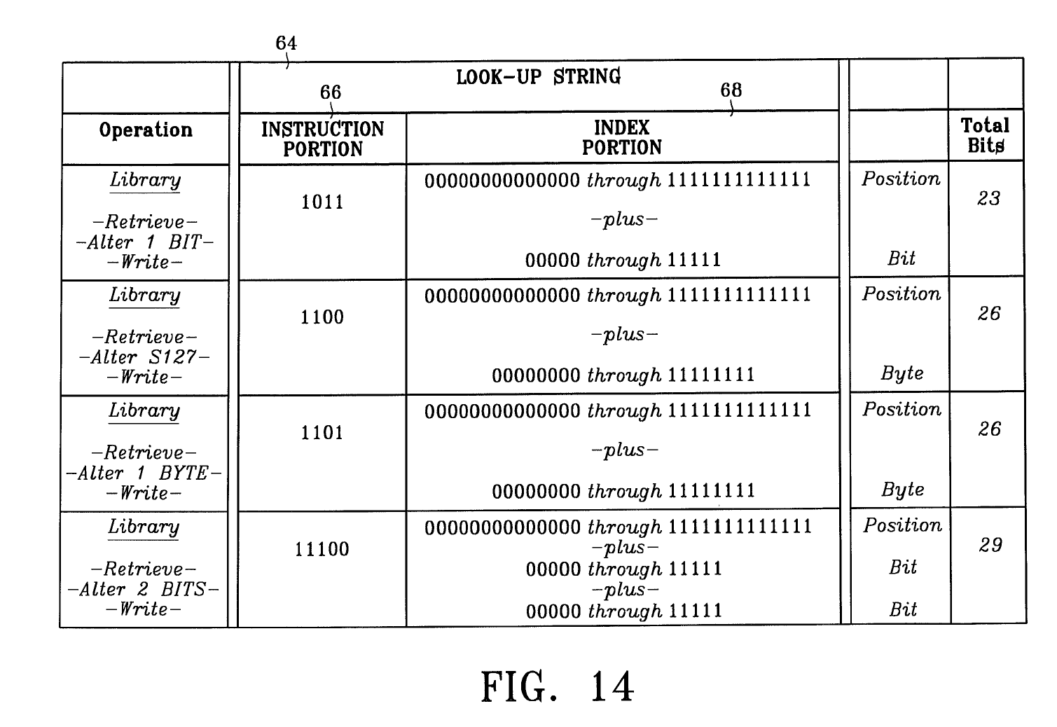

FIG. 14 is a table representing look-up strings 64 designed to cause CPU 28, when executing decompression program 38, to retrieve a code string 54 from library 50, alter that code string 54, and then write the altered code string 54 to output memory 42. The following describes the different alterations performed by CPU 28 when reading a look-up string 64 corresponding to each of the four entries in the table of FIG. 14:

1. An instruction 66 containing the bits 1011 causes CPU 28 to switch a selected bit (0 to 1—or—1 to 0) of a retrieved code string 54. The first fourteen bits of the index 68 of the particular look-up string 64 identifies a selected code string 54 in any segment 52 and indexed position 56 of library 50. The last five bits of the look-up string 64 identify the particular bit in the code string 54 to be switched.

2. An instruction 66 containing the bits 1100 causes CPU 28 to perform an arithmetic operation on a retrieved code string 54. The first fourteen bits of the index 68 of the particular look-up string are an identifier pinpointing a selected code string 54 in any segment 52 and indexed position 56 of library 50. The last eight bits are an arithmetic string, in this case, a signed byte to be added to the code string 54. For that byte, the last bit provides the sign for that byte. A one represents a positive number. A zero represents a negative number or vice versa. The remaining seven bits represent the number ranging between −128 and +127 (base ten) to be added to the retrieved code string 54.

3. An instruction 66 containing the bits 1101 causes CPU 28 to replace a particular byte of a retrieved code string 54. The first fourteen bits of the index 68 of the particular look-up string 64 are an identifier pinpointing a selected code string 54 in any segment 52 and indexed position 56 of library 50. The last eight bits are a replacement—in this case a replacement byte. The particular byte of code string 54 to be replaced is predetermined and set by the instruction 66 of the look-up string 64 and decompression program 38. Potentially, there could be four distinct instructions—each for replacing a different byte of a retrieved code string 54 having 32 bits.

4. An instruction 66 containing the bits 11100 causes CPU 28 to switch two selected bits (0 to 1 or 1 to 0) of a retrieved code string 54. The first fourteen bits of the index 68 of the particular look-up string 64 identifies a selected code string 54 in any segment 52 and indexed position 56 of library 50. The next five bits of the look-up string 64 identify the first particular bit in the code string 54 to be switched, while the last five bits of the look-up string 64 identify the second particular bit in the code string 54 to be switched.

As can be seen from the table of FIG. 14, the four groups of look-up strings 64 designed to alter a code string 54 respectively require twenty-three, twenty-six, twenty-six, and twenty-nine bits. Consequently, when representing a code sting of thirty-two bits, use of the look-up strings 64 of FIG. 13 is preferred. However, depending upon the data compressed, use of one or more of the look-up strings 64 represented in FIG. 14 can be provide a significant benefit.

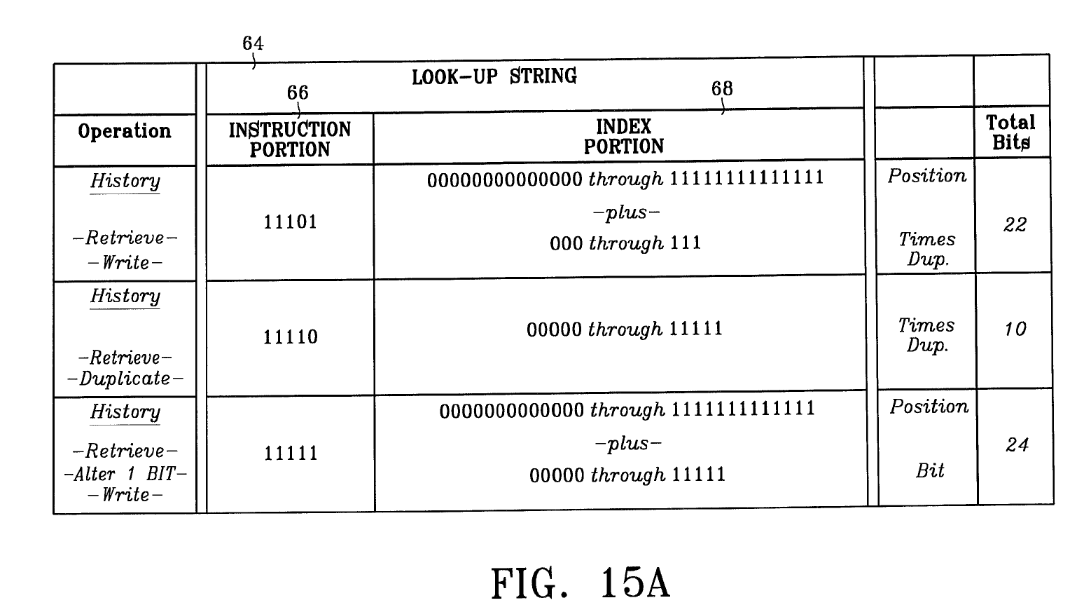

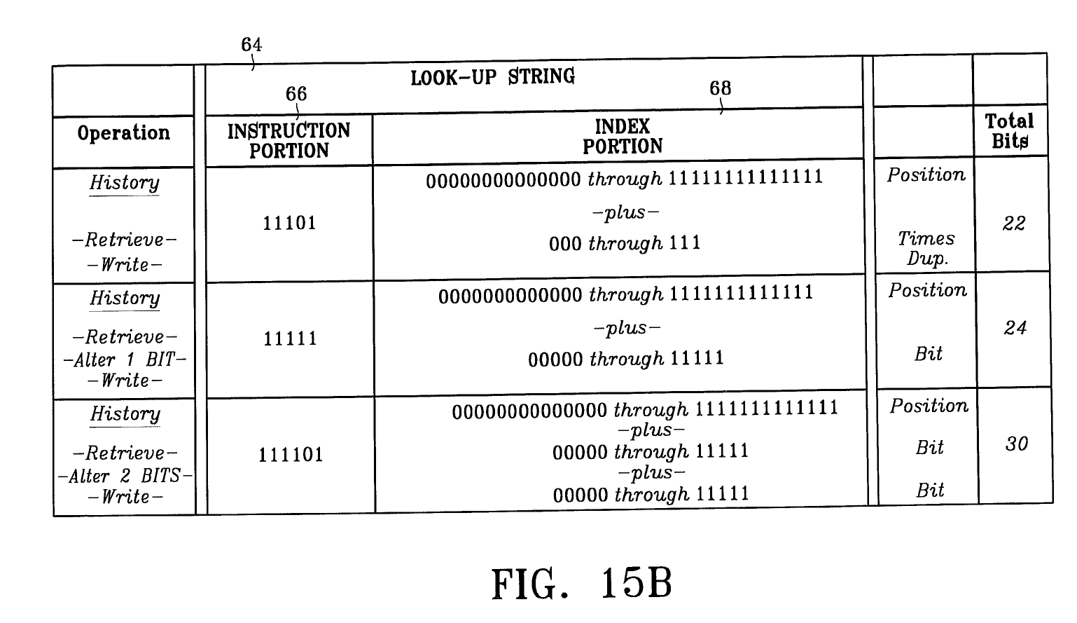

FIGS. 15A and 15B are tables representing look-up strings 64 designed to cause CPU 28, when executing decompression program 38, to retrieve a code string 54 from history cache 40 and then write or duplicate that code string 54 to output memory 42. It is assumed in these examples that each indexed position 60 in history cache 40 can be represented using fourteen bits. The following describes the different alterations performed by CPU 28 when reading a look-up string 64 corresponding to each of the two entries in the table of FIG. 15A:

1. An instruction 66 containing the bits 11101 causes CPU 28 to retrieve a code string 54 from history cache 40 in and indexed position 60 represented by the first fourteen bits of the index 68. Thee last three bits of the index 68 identify the number of times that code string 54 is to be written to output memory 42. The three bits in this example allow the code string 54 to be written up to eight times. A fewer or greater number of bits may be used.

2. An instruction 66 containing the bits 11110 causes CPU 28 to retrieve the most recent entry in history cache 40. The five bits in the index 68 indicate the number of times that code string 54 is to be written to output memory 42. The use of five bits in this example allows the code string 54 to be written up to thirty-two times. A fewer or greater number of bits may be used.

3. An instruction 66 containing the bits 11111 causes CPU 28 to switch a selected bit (0 to 1 or 1 to 0) of a retrieved code string 54. The first fourteen bits of the index 68 of the particular look-up string 64 identifies a selected code string 54 in history cache 40. The last five bits of the look-up string 64 identify the particular bit in the code string 54 to be switched.

The following describes the different alterations performed by CPU 28 when reading a look-up string 64 corresponding to each of the three entries in the table of FIG. 15B:

1. An instruction 66 containing the bits 11101 causes CPU 28 to retrieve a code string 54 from history cache 40 in and indexed position 60 represented by the first fourteen bits of the index 68. Thee last three bits of the index 68 identify the number of times that code-string is to be written to output memory 42. The three bits in this example allow the code string 54 to be written up to eight times. A fewer or greater number of bits may be used.

2. An instruction 66 containing the bits 11110 causes CPU 28 to switch a selected bit (0 to 1 or 1 to 0) of a retrieved code string 54. The first fourteen bits of the index 68 of the particular look-up string 64 identifies a selected code in history cache 40. The last five bits of the look-up string 64 identify the particular bit in the code string 54 to be switched.

3. An instruction 66 containing the bits 11111 causes CPU 28 to switch two selected bits (0 to 1—or—1 to 0) of a retrieved code string 54. The first fourteen bits of the index 68 of the particular look-up string 64 identifies a selected code string 54 in history cache 40. The next five bits of the look-up string 64 identify the first particular bit in the code string 54 to be switched, while the last five bits of the look-up string 64 identify the second particular bit in the code string 54 to be switched.

FIG. 16 is a table representing look-up strings 64 designed to cause CPU 28, when executing decompression program 38, to write the index 68 of the lookup string 64 to output memory 42.

The tables of FIGS. 11-16 are examples only. The selected operations and sizes of library 50 and look-up strings 64 were designed for an ARM processor. In this case, library 50 contains approximately 16,000 code strings 54 each containing thirty-two bits. With a library of this size, as CPU 28 executes decompression program 38, the most accessed code-strings 54 in library 50, if not the entire library 50, naturally migrate to processor cache 46. The same is true for the most repeated instructions of decompression program 38. Consequently, CPU 28 is able to inflate compressed data structure 36 accessing volatile and non-volatile memory as few times as possible. For portable computing systems utilizing an ARM processor, this feature increases the speed at which a program or other data is inflated resulting in better performance and an increased battery life.

However, the specifics for any given library 50 and set of look-up strings 64 is dependent upon many factors including the type of CPU 28 involved, the compiler used when writing the compressed program, and the specifics of the program itself. Code strings 54 need not contain 32 bits. Look-up strings 64 can contain any number of bits. Library 50 can be broken into any number of segments 52 with each segment 52 containing any number of positions 56. History cache 40 can contain any number of indexed positions 60. The types operations performed on code strings 54 are not limited to those described above with reference to FIGS. 13-16. Depending upon the number of bits 58 in each code string 54 and the number of entries in library 50 and history cache 40, it may be desirable to provide an operation for switching three selected bits rather than one or two. It may be desirable to replace two or more bytes of a given code string 54 rather than just one. Moreover, it may be beneficial in some cases to perform an arithmetic operation in which a number greater than 128 is added to or subtracted from a given code string 54. The particular bits in the instruction 66 of a look-up string 64 that identify any given operation are unimportant. The most repeated operations, however, should be represented with the fewest bits.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. A compressed data structure, comprising:
a plurality of code strings; and
a plurality of look-up strings each containing an index identifying a particular code string to be retrieved and an instruction identifying an operation to be performed on the retrieved code string.

2. The data structure of claim 1, wherein at least some of the code strings are positioned in a library and the index of at least one look-up string identifies a position in the library from which a particular code string is to be retrieved.

3. The data structure of claim 2, wherein the library comprises a segmented library, each segment of the library containing at least one code string.

4. The data structure of claim 1, wherein at least some of the code strings are positioned in a history cache and the index of at least one look-up string identifies a position in the history cache from which a particular code string is to be retrieved.

5. The data structure of claim 1, wherein the instruction in a look-up string comprises an instruction to retrieve the code string identified by the index in the look-up string and to write that code string to an output memory.

6. The data structure of claim 1, wherein the instruction in a look-up string comprises an instruction to retrieve the code string identified by the index in the look-up string, alter that code string, and write the altered code string to an output memory.

7. A data processing system, comprising:
a plurality of code strings;
a plurality of look-up strings each containing an index identifying a particular code string and an instruction identifying an operation to be performed on the identified code string; and
a decompression engine operable, for at least one look-up string, to retrieve a code string identified by the index in the look-up string and to perform an operation on or using the retrieved code string according to the instruction in the look-up string.

8. The system of claim 7, wherein at least some of the code strings are positioned in a library and the index of at least one look-up string identifies a position in the library from which a particular code string is to be retrieved.

9. The system of claim 8, wherein the library comprises a segmented library, each segment of the library containing at least one code string and the instruction in a look-up references the library segment containing the code string identified by the instruction in the look-up string.

10. The system of claim 8, further comprising an output memory and wherein the decompression engine is operable to at least perform the functions of:
writing the retrieved code string to the output memory; and
altering the retrieved code string according to the instruction in the lookup string and writing the altered code string to the output memory.

11. The system of claim 9, further comprising a history cache and wherein the decompression engine is further operable to:
write to a position in the history cache a code string recently written to the output memory; and
to retrieve a code string from a position in the history cache identified by the index in a look-up string, the instruction to retrieve from the history cache being provided by the instruction in the look-up string.

12. The system of claim 11, wherein the decompression engine is further operable to repeatedly write the code string retrieved from the history cache a selected number of times, the selected number being identified by the look-up string.

13. The system of claim 11, wherein the decompression engine is further operable to alter the code string retrieved from the history cache and write the altered code string to the output memory, the code string being altered according to the instruction of the look-up string.

14. The system of claim 7, wherein the code string each comprise thirty-two bits.

15. The system of claim 14, wherein at least some of the look-up string includes no more than eight bits.

16. A computing system, comprising:
a first memory location;
a plurality of code strings stored in the first memory location;
a plurality of look-up strings stored in the first memory location, each look-up string containing an index identifying a particular code string to be retrieved and an instruction identifying an operation to be performed on the retrieved code string;
a second memory location;
a decompression program operating from the second memory location, the decompression program comprising machine readable instructions that when executed causes a processor, for at least one look-up string, to retrieve the code string contained in the indexed position identified by the index of the look-up string and to perform an operation on or using the retrieved code string according to the instruction of the look-up string; and
a processor in operative communication with the first and second memory locations, the processor operative to execute the decompression program.

17. The system of claim 16, wherein at least some of the code strings are positioned in a library and the index of at least one look-up string identifies a position in the library from which a particular code string is to be retrieved.

18. The system of claim 17, further comprising a processor cache directly accessible by the processor and wherein the processor is further operable to load into and access from the processor cache at least portions of the library and decompression program.

19. The system of claim 17, wherein the library comprises a segmented library, each segment of the library containing at least one code string and the instruction in a look-up string references the library segment containing the code string identified by the index in the look-up string.

20. The system of claim 17, further comprising an output memory location and wherein the decompression program contains further machine readable instructions for:
writing a retrieved code string to the output memory; and
altering a retrieved code string according to the instruction in the look-up string and writing the altered code string to the output memory.

21. The system of claim 18, further comprising a history cache accessible by the processor, and wherein the decompression program comprises further machine readable instructions for:
writing to a position in the history cache a code string recently written to the output memory; and
retrieving a code string from a position in the history cache identified by the index in the look-up string, the instruction to retrieve from the history cache being provided by the instruction in the look-up string.

22. The system of claim 21, wherein the decompression program comprises further machine readable instructions to repeatedly write the code string retrieved from the history cache a selected number of times, the selected number being identified by the look-up string.

23. The system of claim 21, wherein the decompression program comprises further machine readable instructions for altering the code string retrieved from the history cache according to the instruction in the look-up string and writing the altered code string to the output memory.

24. The system of claim 20, wherein the output memory location and the second memory location are the same.

25. The system of claim 24, wherein the output and second memory locations comprise volatile memory.

26. The system of claim 16, wherein the first memory location comprises non-volatile memory, and the second memory location comprises volatile memory.

27. A method for decompressing a data structure having a plurality of look-up strings and a plurality of code strings, the method comprising:
reading a look-up string;
retrieving a code string identified by the look-up string; and
performing on the retrieved code string an operation identified by the look-up string.

28. The method of claim 27 wherein at least some of the code strings are positioned in a library and the act of retrieving comprises retrieving a code string from a position in the library identified by the look-up string.

29. The method of claim 27, wherein the act of performing comprises writing the retrieved code string to an output memory.

30. The method of claim 27, wherein the act of performing comprises altering the retrieved code-string by one bit and writing the altered code string to an output memory.

31. The method of claim 27, wherein the act of performing comprises altering the retrieved code string by two or more bits and writing the altered code string to an output memory.

32. The method of claim 27, wherein:
a look-up string includes an identifier and an arithmetic string, the identifier being used to identify a code string to be retrieved; and
the act of performing comprises altering the retrieved code string by performing a mathematical operation on the retrieved code string with the arithmetic string and writing the altered code string to an output memory.

33. The method of claim 27, wherein:
a look-up string includes an identifier and a replacement, the identifier being used to identify a code string to be retrieved; and
the act of performing comprises altering the retrieved code string by replacing a selected number of bits in the retrieved code string with the replacement and writing the altered code string to an output memory.

34. The method of claim 27, further comprising:
writing to a position in a history cache one or more code strings recently written to an output memory;
retrieving a code string from a position in the history cache, the position identified by a look-up string; and
performing on the code string retrieved from the history cache an operation identified by the look-up string.

35. The method of claim 34, wherein the act of performing an operation on the code string retrieved from the history cache comprises writing that code string to the output memory.

36. The method of claim 34, wherein the act of performing an operation on the code string retrieved from the history cache comprises writing that code string to the output memory a specified number of times, the number being specified by the look-up string.

37. The method of claim 34, wherein the act of performing an operation on the code string retrieved from the history cache comprises altering the retrieved code string by one bit and writing the altered code string to an output memory.

38. The method of claim 34, wherein the act of performing an operation on the code string retrieved from the history cache comprises altering the retrieved code string by two or more bits and writing the altered code string to an output memory.

39. The method of claim 34, wherein:
a look-up string includes an identifier and an arithmetic string, the identifier being used to identify a code string to be retrieved; and
the act of performing an operation on the code string retrieved from the history cache comprises altering the retrieved code string by performing a mathematical operation on the retrieved code string with the arithmetic string and writing the altered code string to an output memory.

40. The method of claim 34, wherein:
a look-up string includes an identifier and a replacement, the identifier being used to identify a code string to be retrieved; and
the act of performing an operation on the code string retrieved from the history cache comprises altering the retrieved code string by replacing a selected number of bits in the retrieved code string with the replacement and writing the altered code string to an output memory.

41. A computer program product for decompressing a data structure, the data structure containing a plurality of code strings and a plurality of look-up strings, the product comprising a machine useable medium having machine readable instructions thereon for:
reading the look-up strings;
for each look-up string read, retrieving a code string identified by the lookup string and performing on the retrieved code string an operation identified by that look-up string.

42. The product of claim 41, wherein the instructions for performing comprise instructions for writing the retrieved code string to an output memory.

43. The product of claim 41, wherein the instructions of performing comprise instructions for altering the retrieved code string by one bit and writing the altered code string to an output memory.

44. The product of claim 41, wherein the instructions for performing comprise instructions for altering the retrieved code string by two or more bits and writing the altered code string to an output memory.

45. The product of claim 41, wherein:
the index of the look-up string comprises an identifier and a arithmetic string, the identifier being used to identify a codes string to be retrieved; and
the instructions for performing comprises instruction for altering the retrieved code string by performing a mathematical operation on the retrieved code string with the arithmetic string and writing the altered code string to an output memory.

46. The product of claim 41, wherein:
the index of the look-up string comprises an identifier and a replacement, the identifier being used to identify a codes string to be retrieved; and
the instructions for performing comprise instructions altering the retrieved code string by replacing a selected number of bits in the retrieved code string with the replacement and writing the altered code string to an output memory.

47. The product of claim 41, further comprising instructions for:
writing to a history cache one or more code strings recently written to an output memory;
retrieving a code string from a position in the history cache, the position identified by the look-up string; and
performing on the code string retrieved from the history cache an operation identified by the look-up string.

48. The product of claim 47, wherein the instructions for performing an operation on the code string retrieved from the history cache comprise instructions for writing that code string to the output memory.

49. The product of claim 47, wherein the instructions for performing an operation on the code string retrieved from the history cache comprise instructions for writing that code string to the output memory a specified number of times, the number being specified by the look-up string.

50. The product method of claim 47, wherein the instructions for performing an operation on the code string retrieved from the history cache comprise instructions for altering the retrieved code string by one bit and writing the altered code string to the output memory.

51. The product of claim 47, wherein the instructions for performing an operation on the code string retrieved from the history cache comprise instructions for altering the retrieved code string by two or more bits and writing the altered code string to the output memory.

52. The product of claim 47 wherein:
the index of the look-up string comprises an identifier and an arithmetic string, the identifier being used to identify the indexed position in the history cache; and
the instructions for performing an operation on the code string retrieved from the history cache comprise instructions for altering the retrieved code string by performing an mathematical operation on the retrieved code string with the arithmetic string, and writing the altered code string to the output memory.

53. The product of claim 47 wherein:
the index of the look-up string comprises an identifier and a replacement, the identifier being used to identify the indexed position in the history cache; and
the instructions for performing an operation on the code string retrieved from the history cache comprise instructions for altering the retrieved code string by replacing a selected number of bits in the retrieved code string with the replacement and writing the altered code string to the output memory.
